(19) United States
(12) Patent Application Publication
(10) Pub. No.: US 2007/0294759 A1
(43) Pub. Date: Dec. 20, 2007

(54) Wireless network control and protection system

(76) Inventor: Logan Browne, Pleasnt Grove, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/805,041

(22) Filed: May 22, 2007

Related U.S. Application Data
(63) Continuation of application No. 10/357,800, filed on Feb. 3, 2003.

(51) Int. Cl. G06F 17/00; G08B 23/00

(52) U.S. Cl. 726/14; 726/23

(57) ABSTRACT

A local area network and method for operating the same is disclosed. The local computer network is connected to a wide area network by a node that receives network communications from computers on the local network. The node includes a registration system for assigning one of a plurality of predetermined states to each of the computers on the network, the states determining the types of communications allowed by that computer on the wide area network. The registration system assigns a first one of the states to one of the computers when that computer provides registration information to the registration system and a second state when the computer provides authentication information to an authentication site. A computer on the network has restricted access to the wide area network when assigned the first state and less restricted access to the wide area network when assigned the second state.

### FIELD OF THE INVENTION

The present invention relates to security systems for computer networks.

### BACKGROUND OF THE INVENTION

A typical corporate computer network consists of a number of local area networks (LANs) that are connected together to form a wide area network(WAN) that includes servers on the Internet. Each LAN includes a node that manages the traffic between the host computers on that LAN and computers on the portion of the wide area network that is outside of that LAN.

Nodes often provide a firewall to protect the users of the LAN from attacks by hosts on the WAN. However, such firewalls provide one level of access for all hosts on the LAN. Hence, the security at the LAN level is that associated with the most trusted user. Once a user succeeds in signing onto the LAN, that user can communicate with all of the hosts on the WAN. It is up to the hosts on the other LANs to protect themselves either through protection software on the host or in a firewall associated with the LAN on which the host resides.

As computer networks evolve, systems in which the user group associated with each LAN changes over shorter time intervals are becoming more common. Furthermore, a new user can connect to the network through any available network connector without the aid of network administrators or other site personnel. In the past, such personnel have provided some degree of security to the network. Hence, it cannot be assumed that all of the users of a particular LAN are known trusted users.

The introduction of wireless connection points has aggravated this problem even further, since a user with a portable computer can connect to the LAN merely by being within range of a transceiver associated with one of the wireless connections points. LAN transceivers with ranges in the hundreds of feet are often utilized. Hence, in some cases, the range and location of the transceiver are such that a user in a public area can connect to the LAN. As a result, a hostile user would not even need to gain access to a restricted area to obtain access to the network.

The single level of security provided by prior art firewalls is inadequate in such fluid networks. In general, any user within range of a wireless access point can log onto the associated LAN and attack other computers on the LAN or the Internet. Some authentication schemes have been designed into wireless protocols, but generally these require the use of a shared secret, additional specialized hardware, or specific software to operate.

### SUMMARY OF THE INVENTION

The present invention is a local area network and method for operating the same. The local computer network is connected to a wide area network. The local network includes a node that receives network communications from computers on the local network. An authentication site for authenticating computers on the local network is also provided. In the present invention, the node includes a registration system for assigning one of a plurality of predetermined states to each of the computers on the network, the states determining the types of communications allowed by that computer on the wide area network. The registration system assigns a first one of the states to one of the computers when that computer provides registration information to the registration system and a second state when the computer provides authentication information to the authentication site. A computer on the network has restricted access to the wide area network when assigned the first state and less restricted access to the wide area network when assigned the second state.

### BRIEF DESCRIPTION OF THE DRAWINGS

FIG. 1 illustrates a local area network connected to the Internet via a node according to the present invention.

FIG. 2 is a flow chart of an embodiment of a registration method according to one embodiment of the present invention.

FIG. 3 is a flow chart of one embodiment of an attack response protocol according to one embodiment of the present invention.

### DETAILED DESCRIPTION OF THE PREFERRED EMBODIMENTS OF THE INVENTION

The present invention is based on the assumption that any host on a wireless network that is being used in or near a public area should be treated as untrusted or even hostile. When a wireless LAN will be used to provide access to the Internet, care must be taken so that this access is not used to launch an attack on other hosts, since such an attack could subject the LAN owner to legal liability.

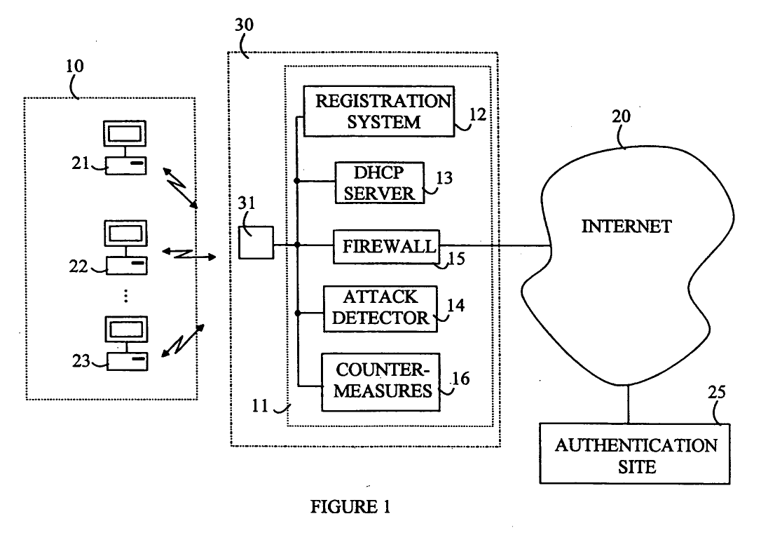

The manner in which the present invention provides its advantages can be more easily understood with reference to FIG. 1, which illustrates a LAN 10 connected to Internet 20 via a node 30 according to one embodiment of the present invention. Exemplary host computers on LAN 10 are shown at 21-23. The computers on LAN 10 are connected to node 30 via wireless links that communicate with a transceiver 31 in node 30; however, the teaching of the present invention can also be applied to networks in which the hosts are connected by cables. Node 30 includes a security system 11 that includes a registration system 12 and a DHCP server 13. Security system 11 also includes an attack detection engine 14, a firewall 15, and a countermeasures engine 16.

When a host computer connects to the network via node 30, DHCP server 13 provides an IP address to the host. DHCP server 13 captures the Media Access Control (MAC) Address of the requesting host's network card when it provides the required IP address. Only hosts that have a captured MAC address and a DHCP provided IP address can register successfully with registration system 12.

Registration system 12 provides the user interface to security system 11, and is the point of integration for the other security system components. Registration preferably occurs via a Secure Sockets Layer (SSL) or Transport Layer Security (TLS) based web application 25 using certificate authentication to identify users based upon well recognized Certification Authorities. Since such authentication systems are known to the art, they will not be discussed in detail here. The Hewlett-Packard Digital Badge and Hewlett-Packard Business Partner Internet Authentication systems are examples of such systems. In the preferred embodiment of the present invention, all web traffic that comes from a DHCP assigned IP is redirected to the SSL registration site. This web application can also be replaced by an IEEE 802.1 x standard digital certificate-based authentication system as this technology matures, and other registration systems are possible.

Registration system 12 assigns a user state to the host computer, and, as will be explained in more detail below, also alters the user state as necessary during the user's period of connection. In the preferred embodiment of the present invention, there are 4 defined user states; however, embodiments having different numbers of states can also be constructed.

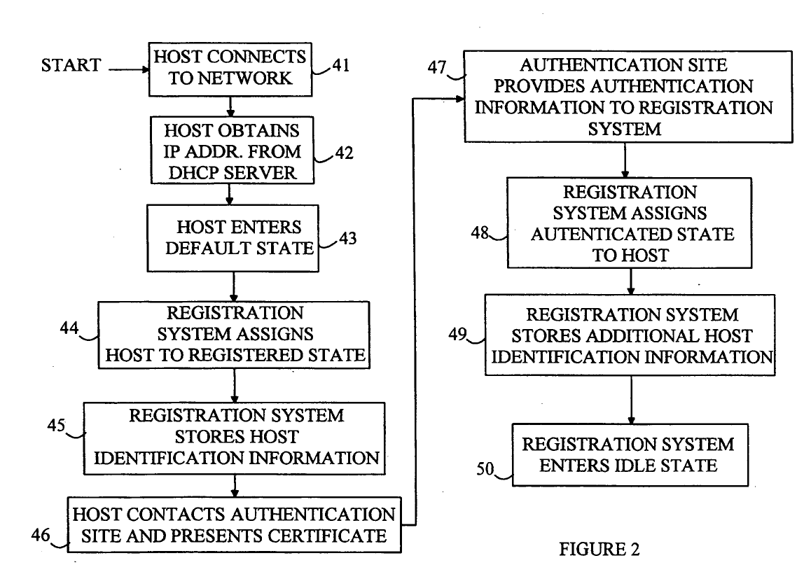

Refer now to FIG. 2, which is a flow chart of an embodiment of a registration method according to one embodiment of the present invention. A host desiring access to the network connects to the network via a wireless access point such as node 30 as shown at 41. The host obtains an IP address from the DHCP server associated with that node as shown at 42. The host is then assigned the lowest security state which is the “default” state as shown at 43. This is the state of the host computer after the host has been assigned an IP address by the DHCP server, but before the host has registered. In this state, any messages sent by the host to a port in a predetermined list of ports will result in the return of an error message, or a redirection to registration web site 25.

The host then registers with the registration system by sending the appropriate messages to registration system 12 as shown at 44. This provides the host with the next highest security state, the “registered” state. This is the state after the user has obtained an IP address and registered with registration system 12. In this state, a host computer can communicate on the Internet, but the communications are limited to a predetermined set of protocols. A registered host preferably has its MAC, OS fingerprint, NETBIOS name, and voluntarily provided user information recorded by registration system 12 as shown at 45. However, embodiments in which other identifying host data is recorded may also be practiced.

A registered host can communicate with authentication site 25. A registered host advances to the next highest security state, the “authenticated” state by providing a valid certificate to the web application at authentication site 25 as shown at 46. Certificate authentication schemes are well known to those skilled in the art, and hence, will not be discussed in detail here. For the purposes of the present discussion, it is sufficient to note that a certificate is an encrypted set of authentication credentials that are issued by a certificate authority. A certificate includes a digital signature from the certificate authority that issued the certificate. Certificates are authenticated by using a public key to verify this digital signature, which is contained in a trusted authority root certificate that is stored at the authentication site.

When the host has successfully completed the authentication process as shown at 47, registration system 12 will be notified by authentication site 25 as shown at 48. Registration system 12 will then advance the security state of the host computer from the registered state to the authenticated state. In this state, the host will be given greater access to the Internet or provided access to a private network. For example, any particular port, protocol, and bandwidth restrictions that are imposed on hosts in the registered state are preferably relaxed or removed altogether in the authenticated state. In addition to the identification data discussed above, authenticated host computers will typically have the authentication certificate data stored by registration system 12 as shown at 49. At this point, the registration process is completed, and registration system 12 enters an idle state as shown at 50.

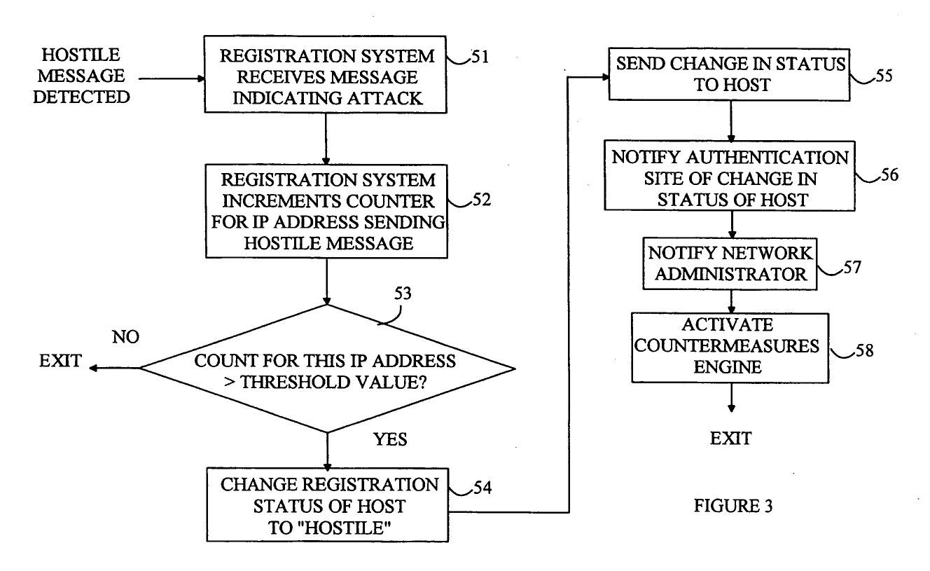

Security system 11 includes an attack detection engine 14 that detects the presence of a given set of common attack vectors in messages that are sent on the network. When one of these attack vectors is detected, attack detection engine 14 sends an alert to registration system 12, which also executes an attack response protocol. Refer now to FIG. 3, which is a flow chart of one embodiment of an attack response protocol according to one embodiment of the present invention. The attack response protocol is triggered when attack detection engine 14 sends a message to the registration system as shown at 51. The message indicates that a hostile message has been detected in a communication between a host computer and another computer on the Internet or the local network. Registration system 12 keeps track of the alert messages associated with each host computer. Upon receiving the alert message, registration system 12 increments the alert message count for the host computer that sent the message as shown at 52. The registration system then tests the message count to determine if the number of alerts for this host has exceeded a threshold value as shown at 53. If the number of alert messages is still less than the threshold value, registration system 12 exits the attack response protocol. If the number of alert messages exceeds the threshold value, registration system 12 alters the security state of the host to the “hostile state” as shown at 54.

When a host enters the hostile state, its Internet privileges are restricted or eliminated. Registration system 12 communicates the change in security state to the host computer in question by sending a message-to the host computer as shown at 55. The message includes an explanation of the reasons for the change in status. Since the illegal behavior may be the fault of a third party application being run by the user on the host computer, and not a hostile intent on the user's part, the message is preferably sent to the host computer using several network messaging protocols to assure that the user receives the message.

Additionally, in the preferred implementation, the network messaging protocols used to inform the host of its change in status are tailored to the specific host based upon the OS fingerprint and other registration information provided during registration. This facilitates the direct transmission of the message to the user. If the hostile actions are being initiated from third party software, that software may also block the incoming messages indicating a change in status. Hence, the message to the user is preferably sent through a system component that is less likely to have been corrupted by the third party program.

In principle, a hostile user could disconnect the host from the network and reconnect to the LAN either at the current node or another node. The host would then re-register, and hence, avoid the change in status. To prevent a host from using this method to avoid the change in status, registration system 12 also notifies authentication site 25 of this change in state as shown at 56. Authentication site 25 will then refuse to authenticate this host until authentication site 25 receives permission from registration system 12, or until some predetermined event has occurred. For example, authentication site 25 can be inhibited from authorizing the host in question for a predetermined period of time. If a host attempts to re-register prior to the inhibition being lifted, authentication site 25 will refuse the authentication request and return a message to the host explaining the reason for the hostile state.

In the preferred embodiment of the present invention, a message containing all relevant information about a hostile host computer is also sent to the appropriate network administrator as shown at 57. The administrator can then take the appropriate actions with respect to the user in question.

In the embodiments of the present invention discussed above, the restrictions placed on the communications to and from a host are implemented via firewall 15. Since firewalls are well known in the computer arts, a detailed discussion of such systems will not be provided here. For the purposes of the present discussion, the firewall may be considered to be a “filter” that blocks messages between a host on the local network and a computer on the wide area network. A message from a host to or from a remote computer is blocked if the message satisfies a rule in a predetermined set of rules. The set of rules applied to the communications involving any given host can be different from those applied to other hosts. Hence, the firewall can be used to block communications to and from a particular host without blocking communications to and from other hosts.

In addition, the restrictions applied to the communications involving a host on the network can be modified at any time by dynamically altering the set of rules applied to that host. Hence, the registration system can implement the changes in restrictions associated with a change in the security state of a host by altering the rule set associated with that host at the firewall. As the security level of the host increases, the restrictive rules associated with the prior security state are removed or altered.

Attack detection engines are known to the art, and hence, will not be discussed in detail here. For the purposes of this discussion, it is sufficient to note that such engines examine the messages being sent on the network for specific characteristics that are associated with hostile actions. In general, the attack detection engine includes a set of rules that define particular attack scenarios. The attack detection engine examines the contents of each packet for a sequence that matches one of the rules. If a match is found, the attack detection engine forwards the packet to a location specified in the rule. In one embodiment of the present invention, the Open Source Network Intrusion Detection Engine, SNORT, is used for the attack engine (available at http://www.snort.org). However other attack engines may be utilized.

Security system 11 also preferably includes a countermeasures engine 16 which is triggered when a predetermined number of alerts is generated by attack detector 14 as shown at 58. As will be explained in more detail below, the countermeasures engine can protect computers outside the local area network by altering the rules used by the firewall to filter messages to and from the Internet.

In addition, countermeasure engines that limit the effect of attacks against other hosts on the same network are known to the art. Such engines are typically utilized when a Denial of Service attack is detected or unauthorized network traffic is detected. The countermeasures may include sending reset messages to the host and target computers to interfere with the communication that is being attempted between the computers. The reset messages received by the target computer appear to come from the hostile host computer. Hence, the target computer disregards the previously sent message from the hostile host computer. Similarly, reset messages generated by the countermeasure engine that appear to originate in the target computer can be sent to the hostile computer. Such messages cause the target computer to think that the last packet was not correctly received, and hence, must be resent. As a result, the hostile computer will never complete its communication since it is constantly resending the same packet. Other types of countermeasures include exploiting security vulnerabilities on a hostile host to shut down the host, or closing a network connection, to remove known malicious programs.

The manner in which the present invention responds to an attack on a remote computer can be more easily understood with reference to a simple example. Consider the case in which a user of the local network attempts to attack a computer on the Internet that has been infected with a “Trojan horse” that permits the attacker to download files from the “victim” user's machine. The Trojan horse is assumed to already be on the remote user's computer. To attack the remote user's machine, the attacking host must activate the Trojan horse and then direct messages to a predetermined list of ports on the remote user's machine.

The form of the activation message is known and available from services that catalog viruses, and other hostile programs. For the purposes of this example, it will be assumed that attack detector 14 has been programmed to detect network traffic that includes the activation message. When attack detector 14 detects this activation message, it alerts the registration system that a hostile message has been sent from a host computer on the local area network. The alert message includes the IP address of the attacking host computer; hence, the registration system knows the identity of the host and the user. If the registration system determines that the host is to be classified as hostile, the registration system alters the host's status as discussed above and initiates the required countermeasures.

The countermeasures engine is then activated to prevent further hostile actions by the attacking host. For example, the countermeasures engine can instruct the firewall to block all outgoing traffic from the attacking host to the remote computer that is under attack. This is accomplished by altering the rule set used by the firewall to filter traffic to and from the attacking computer.

In addition, the countermeasures engine can alter the rule set that is applied to the attacking computer's communications to block all messages to and from the list of ports associated with this Trojan horse regardless of the IP address of the recipient remote computer. It should be noted that the Trojan horse may have already been activated on one or more remote computers by previously sent messages from other local area networks. In this case, the attacking computer does not need to send an activation message to the “victim”. Hence, the attack detector may not have detected all attacks initiated by the local host. Accordingly, once one attack has been recognized, the countermeasures engine can prevent other attacks by changing the rule set at the firewall to block all messages to and from the list of ports in question that involve the attacking host.

It should be noted that embodiments of the present invention in which there are additional security states may also be implemented. For example, a plurality of hostile states can be defined with increasing levels of restriction. For example, in the case discussed above, the host can be assigned to a first hostile state when an activation message from the host is detected. In this state, only countermeasures associated with the Trojan horse in question are taken, i.e., communications to and from the associated list of ports are blocked. The host, however, may still be allowed other Internet communications. If further hostile actions are detected, then the host can be assigned to a second hostile state in which all communications on the Internet are blocked. If the hostile host alters its behavior for a predetermined period of time, the registrations system can return the host to a higher security state.

Such a graded approach provides a means for differentiating actions taken by a hostile user from those taken by an innocent user that are either mistaken for being hostile or the result of unintended actions on the part of the user. In such a system, a host that accidentally generates a packet that is recognized as hostile is not immediately cut-off from access to the Internet. In addition, as noted above, the hostile traffic can be the result of a third party program on the host computer that has hidden hostile code. For example, the host computer may include a virus or other hostile program that has been installed without the user's knowledge. Once the user becomes aware of the hostile communications, the user can shut down the programs causing the communications. In this case, it would be advantageous to allow the user to resume normal communications on the Internet.

The above-described embodiments of the present invention have utilized an authentication site that is located on the Internet. However, embodiments in which the authentication site is located locally can also be constructed. For example, the authentication site could be located on network 10.

The above-described embodiments of the present invention have referred to communications on the Internet. However, the present invention may be practiced with any wide area network in which communications between a local host computer and the wide area network are filtered by a firewall or similar system.

Various modifications to the present invention will become apparent to those skilled in the art from the foregoing description and accompanying drawing. Accordingly, the present invention is to be limited solely by the scope of the following claims.

1-16. (canceled)

17. A node comprising:
a security system configured to communicate with computers of a local network, the security system comprising:
a DHCP server configured to assign computers of the local network an IP address;
an attack detector configured to determine if activities through the node are malicious and to generate an alert message when activities are determined to be malicious; and
a registration system configured to assign one of a plurality of security states to computers of the local network, the plurality of security states determining the types of communications allowed by a computer, wherein the registration system is communicatively coupled with the attack detector and is configured to execute an attack response protocol in response to alert messages received from the attack detector.

18. The node of claim 17 wherein the registration system is configured to alter an assigned state of a computer on the local network.

19. The node of claim 18 wherein the registration system is configured to assign a first state to a computer on the local network when the computer receives an IP address and a second state when the computer has registered with the registration system, the second state providing the computer with restricted access to a wide area network.

20. The node of claim 19 wherein the registration system is configured to assign the computer a third state when the computer is authenticated, the third state providing increased access privileges over the second state.

21. The node of claim 18 wherein the registration system is configured to track alert messages received from the attack detector and assign the computer a fourth state if the number of alert messages associated with the computer exceeds a threshold.

22. The node of claim 21 wherein the registration system is communicatively coupled to an authentication system, the registration system being configured to indicate to the authentication system when the computer has been assigned the fourth state.

23. The node of claim 21 wherein the registration system is configured to notify a network administrator when the computer is assigned the fourth state.

24. The node of claim 17 comprising a firewall through which the computers on the local network may connect with a wide area network.

25. The node of claim 17 comprising a countermeasures module configured to limit the effect of malicious activities if a threshold number of alert messages have been generated by the attack detector.

26. A method of operating a registration system comprising:
assigning one of a plurality of security states to host computers, the security states
determining the access privileges of the host computers, the assigning comprising:
assigning a first state to a host computer when the host computer obtains an IP address from a DHCP server, the first state providing limited access to a local network;
assigning a second state to the host computer when the host computer registers with the registration system, the second state providing limited access to a wide area network; and
assigning a third state to the host computer when the host computer is authenticated, the third state providing increased access privileges over the second state;
receiving and tracking alert messages from an attack detector; and
initiating a security protocol if the number of alert messages associated with the host computer exceeds a threshold amount, the security protocol comprising assigning a fourth state to the host computer, the fourth state restricting access of the host computer previously assigned to the third state.

27. The method of claim 26 wherein assigning the second state comprises storing host identification information at the registration system.

28. The method of claim 26 wherein assigning the third state comprises storing authentication identification information at the registration system.

29. The method of claim 26 wherein tracking alert messages comprises increasing a counter.

30. The method of claim 26 comprising notifying the host computer of change in status when the host computer has been assigned the fourth state.

31. The method of claim 26 comprising notifying an authentication site of the change in status when the host is assigned to the fourth state.

32. The method of claim 26 comprising notifying a network administrator when the host is assigned to the fourth state.

33. The method of claim 26 comprising activating a countermeasures engine when the host is assigned to the fourth state.

34. A system comprising:
a local network comprising one or more host computers;
a node communicatively coupled with the local area network, the node comprising:
a DHCP server configured to assign IP addresses to the one or more host computers;
a registration system configured to dynamically assign one of a plurality of security states to the one or more host computers, the plurality of security states determining the access privileges of the one or more host computers, the registration system assigning a host computer of the one or more host computers to a registered state after the host computer has been assigned an IP address by the DHCP server and has registered with the registration system, the registered state providing limited access to a wide area network; and
an attack detector configured to provide an alert message to the registration system when an attack vector is detected, the registration system being configured to implement a security protocol in response to receiving an alert message, wherein the protocol comprises altering the security state of the host computer.

35. The system of claim 34 wherein an authentication site is located on the wide area network, the registration system being configured to assign the host computer to an authenticated state if the host computer is authenticated by the authentication site, the authenticated state providing increased access privileges over the registered state.
